(19) United States
(12) Patent Application Publication
(10) Pub. No.: US 2024/0078470 A1
(43) Pub. Date: Mar. 7, 2024

(54) Method for Training at least one Machine Learning Algorithm used to Output Specifications for Interventions in the Control System of a Motor Vehicle During Specific Driving Maneuvers

(71) Applicant: Robert Bosch GmbH, Stuttgart (DE)

(72) Inventors: Stefan Lindenau, Benningen (DE); Wadim Napolskich, Bietigheim-Bissingen (DE)

(21) Appl. No.: 18/456,813

(22) Filed: Aug. 28, 2023

(30) Foreign Application Priority Data
Sep. 7, 2022 (DE) 10 2022 209 278.3

(51) Int. Cl. G06N 20/00; B60W 40/09; B60W 50/02; B60W 50/10

(52) U.S. Cl. CPC G06N 20/00; B60W 40/09; B60W 50/0205; B60W 50/10; B60W 2050/021; B60W 2520/105; B60W 2520/14; B60W 2540/18

(57) ABSTRACT

A method for training at least one machine learning algorithm used to output specifications for interventions in the control system of a motor vehicle during specific driving maneuvers is disclosed. The method includes (i) during an operation of the motor vehicle, determining whether at least one specific driving maneuver is being performed; (ii) in the event that a specific driving maneuver is being performed, detecting interventions by a driver of the motor vehicle in the control system of the motor vehicle during the performance of the driving maneuver; and (iii) training the at least one machine learning algorithm based on the specific driving maneuver and the detected interventions by the driver of the motor vehicle in the control system of the motor vehicle.

This application claims priority under 35 U.S.C. § 119 to patent application no. DE 10 2022 209 278.3, filed on Sep. 7, 2022 in Germany, the disclosure of which is incorporated herein by reference in its entirety.

The disclosure relates to a method for training at least one machine learning algorithm used to output specifications for interventions in the control system of a motor vehicle during specific driving maneuvers, which algorithm can be used to evaluate, in a simple manner and consuming few resources, the behavior of at least one component of a control system of the motor vehicle, and/or one component of a control system of at least one similar motor vehicle during the performance of a specific driving maneuver.

### BACKGROUND

Ordinary motor vehicles are more and more equipped with driver assistance systems. In this context, the term “driver assistance systems” is in particular understood to mean additional electronic devices designed to support a driver of a motor vehicle in certain driving situations. Exemplary driver assistance systems of this kind include vehicle dynamics control systems, e.g. electronic stability control systems, which are designed to prevent the vehicle from swerving by selectively braking individual wheels of the vehicle, and which must be integrated into heavy commercial vehicles in particular.

Since such vehicle dynamics control systems intervene in the control system of the motor vehicle, they are extremely relevant to safety and must be adequately tested before they can be used, with very high requirements being placed on the corresponding test methods and/or test systems or the corresponding test specifications.

The testing of such vehicle dynamics control systems is in this context usually based on manual test methods, whereby a general distinction is made between open-loop control systems and closed-loop control systems. Open-loop control systems are based on the fact that predefined driver inputs or interventions in the control system of the motor vehicle are made independently of a vehicle response, and a measured or actual vehicle response is evaluated. Closed-loop controls are also based on the fact that driver inputs that are dependent on the vehicle response are made, and the effort required for this, e.g., the effort required to maintain a specified target course, as well as the extreme values of measured variables that are achieved using the vehicle configuration during the corresponding driving maneuver are evaluated. However, one disadvantage thereby is that such test methods cannot be fully automated, since the behavior and/or responses of a driver during specific driving maneuvers can usually only be recorded manually.

A method for performing a test of a control device found in a vehicle is known from DE 10 2006 031 242 A1, in which at least one operating situation that may arise during operation of the vehicle is automatically simulated.

The disclosure is based on the object of providing an improved test method for evaluating a behavior of at least one component of a control system of a motor vehicle during the performance of specific driving maneuvers.

This object is achieved by means of a method for training a machine learning algorithm used to output specifications for interventions in the control system of a motor vehicle during specific driving maneuvers according to the features described below.

The object is further achieved by means of a system for training a machine learning algorithm used to output specifications for interventions in the control system of a motor vehicle during specific driving maneuvers according to the features described below.

### SUMMARY

According to one embodiment of the disclosure, said object is achieved by means of a method for training at least one machine learning algorithm used to output specifications for interventions in the control system of a motor vehicle during specific driving maneuvers, the method comprising determining, during an operation of the motor vehicle, whether at least one specific driving maneuvers is being performed and detecting, in the event that a specific driving maneuver is being performed, interventions by a driver of the motor vehicle in the control system of the motor vehicle during the performance of the driving maneuver, and training the at least one machine learning algorithm based on the specific driving maneuver and the detected interventions by the driver of the motor vehicle in the control system of the motor vehicle.

In this context, the term “driving maneuver” is understood to mean a maneuver or an intervention in the control system of the motor vehicle in order to obtain a vehicle response.

The terms “control system of the motor vehicle” or “components of the control system of the motor vehicle” also refer to components required for controlling, operating, or driving a motor vehicle, in particular components of the motor vehicle that interact with a drive train of the motor vehicle.

Machine learning algorithms are also based on statistical methods used to train a data processing system such that it can perform a particular task without being originally programmed explicitly for this purpose. The goal of machine learning is to construct algorithms that can learn and make predictions based on data. These algorithms create mathematical models, by means of which, e.g., data can be classified.

A machine learning algorithm is therefore trained and is designed to automatically specify interventions of a driver in the control system of a motor vehicle in the presence of specific driving maneuvers. Based on the machine learning algorithm, the evaluation of a behavior of at least one component of a control system of a motor vehicle during specific driving maneuvers can thus be automated. Doing so has the advantage that the evaluation or the corresponding test method is less error-prone and more robust than manual test methods. In addition, the machine learning algorithm can also be applied to similar motor vehicles without having to first develop elaborate test methods and/or test systems in each case, so the behavior of at least one component of a control system of the motor vehicle and of a component of a control system of at least one similar motor vehicle can be evaluated in a simple manner and using few resources, in particular comparatively low demand for memory and/or processor capacities. The at least one similar motor vehicle can in particular be a motor vehicle from the same manufacturer, which should have similar driving characteristics.

In overall terms, provided thereby is an improved test method for evaluating a behavior of at least one component of a control system of a motor vehicle during the performance of specific driving maneuvers.

The training of the at least one machine learning algorithm can thereby comprise training the at least one machine learning algorithm based on the determined driving maneuver, the detected interventions by the driver of the motor vehicle in the control system of the motor vehicle, and information about the driver of the motor vehicle.

The phrase “information about the driver of the motor vehicle” is in this context understood to mean information characterizing the driver's driving behavior, e.g., whether the driver usually drives in a sportier or more restrained manner, what make of vehicle the driver usually drives, or what type of vehicle the driver usually drives.

Doing so can further improve the robustness of the appropriately trained machine learning algorithm and also the evaluation of a behavior of at least one component of a control system of a motor vehicle during the performance of specific driving maneuvers.

The interventions by the driver of the motor vehicle in the control system of the motor vehicle can further include a change in a steering angle, and/or a change in a vehicle acceleration, and/or a change in a yaw rate.

The term “steering angle” is in this context understood to mean a mean wheel steering angle of the wheels of the motor vehicle, specified in particular by a driver of a motor vehicle via a steering system.

The term “vehicle acceleration” is further understood to mean an acceleration of the motor vehicle or an increase in the speed of the motor vehicle per unit of time.

The term “yaw rate” is further understood to mean the angular velocity of rotation of a motor vehicle about the vertical axis of the motor vehicle.

In particular, all interventions in the control system of a motor vehicle already being monitored by standard in ordinary motor vehicles can be monitored or recorded without the need for complex and costly modifications.

However, the fact that the interventions by the driver of the motor vehicle in the control system of the motor vehicle include a change in a steering angle, and/or a change in a vehicle acceleration, and/or a change in a yaw rate relates to only one possible embodiment. For example, said interventions in the control system of the motor vehicle can include changing the wheel speeds of one or more wheels of the motor vehicle.

The respective at least one driving maneuver can in each case be further specified by means of a test specification.

The term “test specification” is in this context understood to mean a set of specifications and preparations required in order to perform a specific test case.

As a result, the machine learning algorithm can be optimally adapted to corresponding cases of need, so the evaluation of a behavior of at least one component of a control system of a motor vehicle during the performance of specific driving maneuvers can be further improved.

In another embodiment of the disclosure, also provided is a method for evaluating a behavior of at least one component of a control system of a motor vehicle during the performance of at least one specific driving maneuver, the method comprising providing a machine learning algorithm used to output specifications for interventions in the control system of a motor vehicle during specific driving maneuvers, in which case the machine learning algorithm has been trained by a method described hereinabove for training a machine learning algorithm used to output specifications for interventions in the control system of a motor vehicle during specific driving maneuvers, testing the at least one component of a control system of a vehicle using the machine learning algorithm provided to output motor vehicle control intervention specifications during specific driving maneuvers in order to provide test results, and evaluating the behavior of the at least one component of the control system of a motor vehicle during the performance of the at least one specific driving maneuver based on the test results.

A method for evaluating a behavior of at least one component of a control system of a motor vehicle during the performance of at least one specific driving maneuver is therefore disclosed, which method is based on a machine learning algorithm used to output specifications for interventions in the control system of a motor vehicle during specific driving maneuvers, and which enables an improved test method for evaluating a behavior of at least one component of a control system of a motor vehicle during the performance of specific driving maneuvers. In particular, the method is based on a machine learning algorithm designed to automatically indicate driver interventions in the presence of specific driving maneuvers. Based on the machine learning algorithm, the evaluation of a behavior of at least one component of a control system of a motor vehicle during the performance of specific driving maneuvers can thus be automated. Doing so has the advantage that the evaluation or the corresponding test method is less error-prone and more robust compared to manual test methods. In addition, the machine learning algorithm can also be applied to similar motor vehicles without having to first develop elaborate test methods and/or test systems in each case, so that the behavior of at least one component of a control system of the motor vehicle and of a component of a control system of at least one similar motor vehicle can be evaluated in a simple manner and using few resources, in particular comparatively low demand for memory and/or processor capacities.

In another embodiment of the disclosure, also provided is a system for training at least one machine learning algorithm used to output specifications for interventions in the control system of a motor vehicle during specific driving maneuvers, the system comprising a determination unit which is designed to determine, during an operation of the motor vehicle, whether at least one specific driving maneuver is being performed, at least one detection unit which is designed to detect, in the event that a specific driving maneuver is being performed, interventions by a driver of the motor vehicle in the control system of the motor vehicle during the performance of the driving maneuver, and a training unit which is designed to train the at least one machine learning algorithm based on the specific driving maneuver and based on the detected interventions by a driver of the motor vehicle in the control system of the motor vehicle.

A system is therefore disclosed for providing an improved test method for evaluating a behavior of at least one component of a control system of a motor vehicle during the performance of specific driving maneuvers. In particular, a system is specified which is designed to train a machine learning algorithm which is designed to automatically specify interventions by a driver in the presence of specific driving maneuvers. Based on the machine learning algorithm, the evaluation of a behavior of at least one component of a control system of a motor vehicle during the performance of specific driving maneuvers can thus be automated. Doing so has the advantage that the evaluation or the corresponding test method is less error-prone and more robust compared to manual test methods. In addition, the machine learning algorithm can also be applied to similar motor vehicles without having to first develop elaborate test methods and/or test systems in each case, so that the behavior of at least one component of a control system of the motor vehicle and of a component of a control system of at least one similar motor vehicle can be evaluated in a simple manner and consuming few resources, in particular comparatively low demand for memory and/or processor capacities.

The training unit can be designed to train the at least one machine learning algorithm based on the driving maneuver performed, the detected interventions by the driver of the motor vehicle in the control system of the motor vehicle, and information about the driver of the motor vehicle. Doing so can further improve the robustness of the appropriately trained machine learning algorithm and also the evaluation of a behavior of at least one component of a control system of a motor vehicle during the performance of specific driving maneuvers.

The interventions by the driver of the motor vehicle in the control system of the motor vehicle can in turn also include a change in a steering angle, and/or a change in a vehicle acceleration, and/or a change in a yaw rate. In particular, all interventions in the control system of a motor vehicle already being monitored by standard in ordinary motor vehicles can be monitored or recorded without the need for complex and costly modifications.

However, the fact that the interventions by the driver of the motor vehicle in the control system of the motor vehicle include a change in a steering angle, and/or a change in a vehicle acceleration, and/or a change in a yaw rate again represents only one possible embodiment. For example, the interventions in the control system of the motor vehicle can include changing the wheel speeds of one or more wheels of the motor vehicle.

The at least one driving maneuver can in turn further be specified in each case by a test specification. The machine learning algorithm can as a result be optimally adapted to corresponding cases of need, so the evaluation of a behavior of at least one component of a control system of a motor vehicle during the performance of specific driving maneuvers can be further improved.

In a further embodiment of the disclosure, also provided is a system for evaluating a behavior of at least one component of a control system of a motor vehicle during the performance of at least one specific driving maneuver, the system comprising a provisioning unit designed to provide a machine learning algorithm used to output specifications for interventions in the control system of a motor vehicle during specific driving maneuvers, the machine learning algorithm having been trained by a system described hereinabove for training a machine learning algorithm used to output specifications for interventions in the control system of a motor vehicle during specific driving maneuvers, a test unit designed to test the at least one component of a control system of a motor vehicle using the machine learning algorithm provided to output motor vehicle control intervention specifications during specific driving maneuvers in order to provide test results, and an evaluation unit designed to evaluate the behavior of the at least one component of the control system of a motor vehicle during the performance of the at least one specific driving maneuver based on the test results.

A system for evaluating a behavior of at least one component of a control system of a motor vehicle during the performance of at least one specific driving maneuver is therefore disclosed, which system is based on a machine learning algorithm used to output specifications for interventions in the control system of a motor vehicle during specific driving maneuvers and enables an improved test method for evaluating a behavior of at least one component of a control system of a motor vehicle during the performance of specific driving maneuvers. In particular, the system is based on a machine learning algorithm, which is designed to automatically specify interventions by a driver in the presence of specific driving maneuvers. Based on the machine learning algorithm, the evaluation of a behavior of at least one component of a control system of a motor vehicle during the performance of specific driving maneuvers can thus be automated. Doing so has the advantage that the evaluation or the corresponding test method is less error-prone and more robust compared to manual test methods. In addition, the machine learning algorithm can also be applied to similar motor vehicles without having to first develop elaborate test methods and/or test systems in each case, so the behavior of at least one component of a control system of the motor vehicle and of a component of a control system of at least one similar motor vehicle can be evaluated in a simple manner and using few resources, in particular comparatively low demand for memory and/or processor capacities.

In summary, the present disclosure provides a method for training at least one machine learning algorithm used to output specifications for interventions in the control system of a motor vehicle during specific driving maneuvers, which method can be used to evaluate, in a simple manner and using few resources, the behavior of at least one component of a control system of the motor vehicle and/or one component of a control system of at least one similar motor vehicle during the performance of a specific driving maneuver.

Further possible embodiments, developments, and implementations of the disclosure also include feature combinations not described or explicitly specified hereinabove or hereinafter with respect to exemplary embodiments.

### BRIEF DESCRIPTION OF THE DRAWINGS

The accompanying drawings are intended to provide a better understanding of the embodiments of the disclosure. The drawings illustrate embodiments and, in connection with the description, serve to explain principles and concepts of the disclosure.

Further embodiments and many of the specified advantages will emerge with reference to the drawings. The elements shown in the drawings are not necessarily drawn to scale with respect to one another.

Shown are:

FIG. 1 a flowchart of a method for evaluating a behavior of at least one component of a control system of a motor vehicle during the performance of specific driving maneuvers according to embodiments of the disclosure; and

FIG. 2 a schematic block diagram of a system for training at least one machine learning algorithm used to output specifications for interventions in the control system of a motor vehicle during specific driving maneuvers according to embodiments of the disclosure.

### DETAILED DESCRIPTION

In the figures shown in the drawings, identical reference signs denote identical or functionally identical elements, parts, or components, unless stated otherwise.

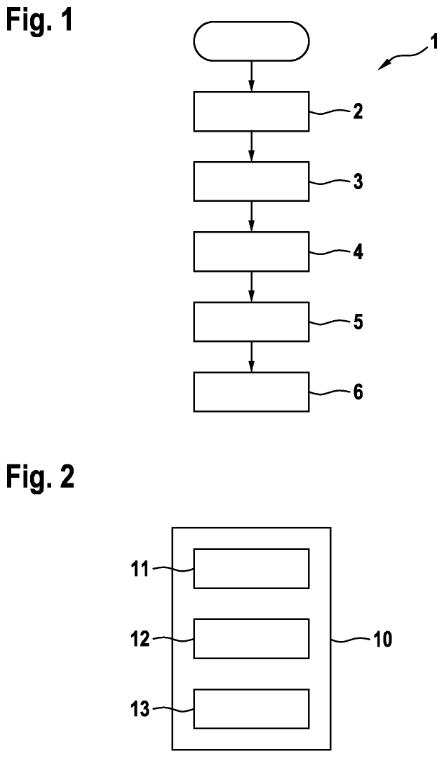

FIG. 1 shows a flowchart of a method for evaluating a behavior of at least one component of a control system of a motor vehicle during the performance of specific driving maneuvers 1 according to embodiments of the disclosure.

Ordinary motor vehicles are more and more equipped with driver assistance systems. The term “driver assistance systems” is in this context understood to mean additional electronic devices, in particular designed to support a driver of a motor vehicle in specific driving situations. Exemplary of such driver assistance systems are vehicle dynamics control means, e.g., electronic stability control means designed to prevent the vehicle from swerving by selectively braking individual wheels of the vehicle, and which must be integrated into heavy commercial vehicles in particular.

Since such vehicle dynamics control systems intervene in the control system of the motor vehicle, they are extremely relevant to safety and must be adequately tested before they can be used, with very high demands being placed on the corresponding test methods and/or test systems.

The testing of such vehicle dynamics control systems is usually based on manual test methods, whereby a general distinction is made between open-loop control systems and closed-loop control systems. Open-loop controls are based on the fact that predefined driver inputs or interventions in the control system of the motor vehicle are made independently of a vehicle reaction, and a measured or actual vehicle response is evaluated. Closed-loop controls are also based on the fact that driver inputs that are dependent on the vehicle response are made and the effort required for this, e.g., the effort required to maintain a specified target course, and the extreme values of measured variables that are achieved using the vehicle configuration during the corresponding driving maneuver are evaluated. However, one disadvantage thereby is that such test methods cannot be fully automated, since the behavior and/or responses of a driver during specific driving maneuvers can usually only be recorded manually.

FIG. 1 shows a method 1, which comprises a step 2 of determining, during an operation of the motor vehicle, whether at least one specific driving maneuver is being performed, a step 3 of detecting interventions by a driver of the motor vehicle in the control system of the motor vehicle during the performance of the driving maneuver (in the event that a specific driving maneuver is being performed), and a step 4 of training at least one machine learning algorithm used to output specifications for interventions in the control system of a motor vehicle during specific driving maneuvers based on the specific driving maneuver and the detected interventions by the driver of the motor vehicle in the control system of the motor vehicle.

A machine learning algorithm is therefore trained, which is designed to automatically specify interventions by a driver in the presence of specific driving maneuvers. Based on the machine learning algorithm, the evaluation of a behavior of at least one component of a control system of a motor vehicle during the performance of specific driving maneuvers can thus be automated. Doing so has the advantage that the evaluation or the corresponding test method is less error-prone and more robust compared to manual test methods. In addition, the machine learning algorithm can also be applied to similar motor vehicles without first having to develop elaborate test methods and/or test systems in each case, so the behavior of at least one component of a control system of the motor vehicle and one component of a control system of at least one similar motor vehicle, e.g., a motor vehicle from the same manufacturer, can be evaluated in a simple manner and using few resources, in particular comparatively low demand for memory and/or processor capacities.

Overall, this provides an improved test method for evaluating a behavior of at least one component of a control system of a motor vehicle during the performance of specific driving maneuvers.

In particular, FIG. 1 shows a method 1 in which a special driver model in the form of a machine learning algorithm can be generated based on data obtained during previous or past journeys or the previous performance of corresponding test methods, in which the data are measured, stored, and then used accordingly to train the at least one machine learning algorithm.

For example, the machine learning algorithm can be an artificial neural network. The artificial network can feature a comparatively simple architecture and comparatively few intermediate layers, since only driving or test sequences with a duration of around twenty to thirty seconds need be specified.

The at least driving maneuver can also be, e.g., a lane change or a calibration test.

According to the embodiments shown in FIG. 1, the step 4 for training the at least one machine learning algorithm further comprises training the at least one machine learning algorithm based on the driving maneuver performed, the detected interventions by the driver of the motor vehicle in the control system of the motor vehicle, and information about the driver of the motor vehicle.

In particular, a separate machine learning algorithm can be trained for each vehicle manufacturer and/or each vehicle type.

According to the embodiments shown in FIG. 1, the interventions by the driver of the motor vehicle in the control system of the motor vehicle in turn further include a change in a steering angle, and/or a change in a vehicle acceleration, and/or a change in a yaw rate.

The at least one machine learning algorithm can therefore be trained based on data collected by sensors integrated as standard in ESP vehicles.

Furthermore, the respective at least one driving maneuver is in each case specified by means of a test specification.

The at least one trained machine learning algorithm can subsequently be used, e.g., for the automated performance of corresponding system tests or for evaluating a behavior of at least one component of a control system of a motor vehicle during the performance of specific driving maneuvers.

As shown in FIG. 1, the method 1 further comprises a step 5 for testing at least one component of the control system of the vehicle using a corresponding trained machine learning algorithm used to output specifications for interventions in the control system of a motor vehicle during the performance of specific driving maneuvers in order to provide test results, and a step 6 for evaluating the behavior of the at least one component of the control system of the motor vehicle during the performance of specific driving maneuvers based on the test results.

The step 5 for testing at least one component of the control system of the vehicle using the at least one trained machine learning algorithm used to output information about behavior by a virtual driver of a motor vehicle during the performance of specific driving maneuvers can thereby in particular comprise a virtual performance of the test method, in which case the vehicle is steered or controlled based on artificial intelligence and the corresponding machine learning algorithm in particular.

The step 6 for evaluating the behavior of the at least one component of the control system of the motor vehicle while performing the specific driving maneuvers based on the test results can further comprise comparing the test results to corresponding threshold values.

The results of the evaluation of the behavior of the at least one component of the control system of the motor vehicle can subsequently be used to, e.g., develop vehicle components, such as a braking system.

Alternatively, based on the at least one trained machine learning algorithm, an evaluation or validation of the results of corresponding manual test methods can be performed.

FIG. 2 shows a schematic block diagram of a system for training at least one machine learning algorithm used to output specifications for interventions in the control system of a motor vehicle during specific driving maneuvers 10 according to embodiments of the disclosure.

As shown in FIG. 2, the system 10 comprises a determination unit 11 which is designed to determine, during an operation of the motor vehicle, whether at least one specific driving maneuver is being performed, at least one detection unit 12 which is designed, in the event that a specific driving maneuver is being performed, to detect interventions by a driver of the motor vehicle in the control system of the motor vehicle during the performance of the driving maneuver, and a training unit 13 which is designed to train the at least one machine learning algorithm based on the specific driving maneuver and the detected interventions of the driver of the motor vehicle in the control system of the motor vehicle.

The determination unit and the training unit can, e.g., each be implemented based on code stored in a memory and executable by means of a processor. The at least one detection unit can further be, e.g., a vehicle sensor or a receiver designed to receive corresponding sensor data.

The determination unit can further be designed to determine, based on data from a control system and/or from at least one control unit of the motor vehicle, whether at least one specific driving maneuver is being performed.

According to the embodiments shown in FIG. 2, the training unit 13 is thereby further designed to train the at least one machine learning algorithm based on the driving maneuver performed, the detected interventions of the driver of the motor vehicle in the control system of the motor vehicle, and information about the driver of the motor vehicle.

The interventions by the driver of the motor vehicle in the control system of the motor vehicle in turn further include a change in a steering angle, a change in a vehicle acceleration, and a change in a yaw rate.

In addition, the respective at least one driving maneuver is in turn specified in each case by means of a test specification.

In particular, the system 10 can be designed to perform a method described hereinabove for training at least one machine learning algorithm used to output specifications for interventions in the control system of a motor vehicle during specific driving maneuvers.

What is claimed is:

1. A method for training at least one machine learning algorithm used to output specifications for interventions in the control of a motor vehicle during specific driving maneuvers, said method comprising:
during an operation of the motor vehicle, determining whether one of at least one specific driving maneuver is being performed;
in the event that a specific driving maneuver is being performed, detecting interventions by a driver of the motor vehicle in the control system of the motor vehicle during the performance of the driving maneuver; and
training the at least one machine learning algorithm based on the specific driving maneuver and the detected interventions by the driver of the motor vehicle in the control system of the motor vehicle.

2. The method according to claim 1, wherein training the at least one machine learning algorithm comprises training the at least one machine learning algorithm based on the determined driving maneuver, the detected interventions by the driver of the motor vehicle in the control system of the motor vehicle, and information about the driver of the motor vehicle.

3. The method according to claim 1, wherein the interventions by the driver of the motor vehicle in the control system of the motor vehicle include a change in a steering angle, and/or a change in a vehicle acceleration, and/or a change in a yaw rate.

4. The method according to claim 1, wherein the respective at least one driving maneuver is in each case specified by way of a test specification.

5. A method for evaluating a behavior of at least one component of a control system of a motor vehicle during the performance of at least one specific driving maneuver, the method comprising:
providing a machine learning algorithm used to output specifications for interventions in the control system of a motor vehicle during specific driving maneuvers, wherein the machine learning algorithm has been trained by a method for training a machine learning algorithm used to output specifications for interventions in the control system of a motor vehicle during specific driving maneuvers according to claim 1;
testing the at least one component of the control system of the vehicle using the provided machine learning algorithm used to output specifications for interventions in the control system of a motor vehicle during specific driving maneuvers in order to provide test results; and
evaluating the behavior of the at least one component of the control system of the motor vehicle during performance of the at least one specific driving maneuver based on the test results.

6. A system for training at least one machine learning algorithm used to output specifications for interventions in the control system of a motor vehicle during specific driving maneuvers, wherein the system comprises a determination unit which is designed to determine, during an operation of the motor vehicle, whether at least one specific driving maneuver is being performed, at least one detection unit which, in the event a specific driving maneuver is being performed, is designed to detect interventions by a driver of the motor vehicle in the control system of the motor vehicle while the driving maneuver is being performed, and a training unit which is designed to train the at least one machine learning algorithm based on the specific driving maneuver and the detected interventions by the driver of the motor vehicle in the control system of the motor vehicle.

7. The system according to claim 6, wherein the training unit is designed to train the at least one machine learning algorithm based on the specific driving maneuver, the detected interventions by the driver of the motor vehicle in the control system of the motor vehicle, and information about the driver of the motor vehicle.

8. The system according to claim 6, wherein the interventions by the driver of the motor vehicle in the control system of the motor vehicle include a change in a steering angle, and/or a change in a vehicle acceleration, and/or a change in a yaw rate.

9. The system according to claim 6, wherein the respective at least one driving maneuver is in each case specified by way of test specifications.

10. A system for evaluating a behavior of at least one component of a control system of a motor vehicle during the performance of specific driving maneuvers, wherein the system comprises a provision unit which is designed to provide a machine learning algorithm used to output specifications for interventions in the control system of a motor vehicle during specific driving maneuvers, wherein the machine learning algorithm has been trained by a system for training a machine learning algorithm used to output specifications for interventions in the control system of a motor vehicle during specific driving maneuvers according to claim 6, a test unit which is designed to test the at least one component of the control system of the vehicle using the machine learning algorithm provided to output motor vehicle control intervention specifications during specific driving maneuvers in order to provide test results, and an evaluation unit which is designed to evaluate the behavior of the at least one component of the control system of the vehicle during the performance of the at least one specific driving maneuver based on the test results.
